(19) United States
(12) Patent Application Publication
(10) Pub. No.: US 2013/0117665 A1
(43) Pub. Date: May 9, 2013

(54) SYSTEM AND METHOD FOR INDIVIDUALIZED MEDIA PUBLISHING

(71) Applicants: Alivia Tagliaferri, Washington, DC (US); Geordie Korper, Fairfax Station, VA (US); Derrick Greene, Lansdowne, VA (US)

(72) Inventors: Alivia Tagliaferri, Washington, DC (US); Geordie Korper, Fairfax Station, VA (US); Derrick Greene, Lansdowne, VA (US)

(73) Assignee: IRONCUTTER MEDIA, LLC, Washington, DC (US)

(21) Appl. No.: 13/320,788

(22) PCT Filed: Jul. 28, 2011
(86) PCT No.: PCT/US11/45707

§ 371 Date: Nov. 16, 2011

Related U.S. Application Data
(60) Provisional application No. 61/368,904, filed on Jul. 29, 2010.

(51) Int. Cl. G06F 17/24

(52) U.S. Cl. CPC G06F 17/24
USPC 715/255

(57) ABSTRACT

A system and method of individualized media publishing including a customization server configured to receive an electronic work from a content creator, create a custom field within the electronic work, and store the custom field in a database or a memory storage device. The system and method receives a request for a customized electronic work from a consumer, and transmits a notification to the content creator informing the content creator of the request for the customized electronic work. The system inserts customized content created by the content creator into the custom field and creates the customized electronic work. The customized electronic work may then be delivered to the consumer.

### CROSS REFERENCES TO RELATED APPLICATIONS

This application claims the benefit of U.S. Provisional Patent Application Ser. No. 61/368,904, filed on Jul. 29, 2010, the contents of which are incorporated herein by reference in their entirety.

### FIELD

The present disclosure relates to electronic media publishing. More particularly, the present disclosure relates to systems and methods for individualized media publishing for electronic or digital works.

### BACKGROUND

Electronic books (“e-books”), music, videos, and other electronic or digital media available for purchase through, for example, Internet websites have become increasingly popular with potential consumers as an alternative to purchasing physical versions of such media. For example, a consumer may purchase an e-book from an online distributor (e.g., Amazon). To purchase an e-book, a potential consumer may electronically access a website of the online distributor, whereby the consumer submits financial information to purchase the e-book or a pre-existing account associated with the consumer is charged by the online distributor for the purchase. Once purchased, the e-book is available to view via an e-book reader or another type of computer device capable of displaying the e-book. Use of the e-book may be subject to certain terms and conditions that the consumer agrees to prior to purchase. Other types of electronic or digital media may be purchased and viewed or listened to using similar processes.

In contrast to the purchase of electronic or digital media, consumers of hard-copy versions of media (such as conventional books, music, videos, and other media) own physical versions of the media which may be customized or personalized by the consumer or the author of the work. For example, consumers often customize conventional books by requesting an autograph and/or personalized message from the author or include personalized messages when the book is a gift to someone else. Moreover, bookstores often hold events allowing individuals to have books signed by the author. For electronic or digital media, however, users do not have adequate ways to obtain personalized or signed copies of the electronic media or adequate methods to customize the purchased electronic media.

Currently, electronic or digital media do not offer an efficient and useful manner for users or consumers to customize or personalize the electronic or digital media either at the time of purchase or anytime thereafter. For example,after purchase, users may manipulate the digital media files, to the extent the digital media files are not protected by digital rights management (DRM) software which prevents users from manipulating the digital media files, to insert other materials created by the user such as image or message files. This method is not an efficient manner for customization as it involves complicated methods for extracting data and inserting new files into the existing digital media file. In addition, such methods may violate copyright laws and the terms of use a consumer agrees to upon purchasing digital media.

Similarly, the difficulty in customizing electronic or digital media is not just applicable to the user or consumer but also the creator or author of the work as existing methods do not provide an adequate or efficient manner to autograph, customize, or personalize an electronic copy of his or her work purchased by a user.

Moreover, problems may exist in modifying or changing the content of the media file after publication. In conventional media (for example, physical versions of books, music, and videos), there are limitations for both the creator and the publisher of the media such as an inability to modify the published version of the book. This may require the creator and publisher to repeat the publishing process thereby creating a new version of the book. Purchasers of the prior version interested in the modifications, therefore, may be required to purchase or obtain the new version of the book. This problem also exists for current electronically published books and other digital media since the publishing process is only concerned with creating a version of the digital media file to be sold to potential consumers and if future changes occur, consumers may be required to purchase a new version.

### SUMMARY

In an illustrative embodiment, a computer implemented system and method for publishers and authors to provide customized electronic books (e-books) for each consumer is disclosed. Generally, the system and method are presented and/or implemented through a web based application.

In an illustrative embodiment, a method of individualized media publishing is disclosed. The method includes, but is not limited to, the steps of one or more servers receiving an electronic work, receiving an indication of an area for customization within the electronic work, creating a custom field within the electronic work associated with the area for customization, and storing the custom field in a database or a memory storage device and/or system.

In another illustrative embodiment, a system for individualized media publishing is disclosed. The system includes, but is not limited to, one or more servers that, either individually or in combination, are in communication with a content creator device and a consumer device. The one or more servers may be configured to receive a request for a customized electronic work, create a custom field within an electronic work, insert customized content into the custom field creating the customized electronic work, and electronically deliver the customized electronic work.

In yet another illustrative embodiment, a system for individualized media publishing is disclosed. In this embodiment, the system includes a server, including but not limited to a microprocessor, accessible by a content creator device, and a database in communication with the server. The microprocessor may be configured to run a computer program, stored in a non-transitory computer-readable medium, that allows the microprocessor to open an electronic work, create a custom field within the electronic work, and store the custom field in the database.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates an exemplary embodiment of a system architecture for individualized media publishing;

FIG. 2 illustrates an exemplary embodiment of a system architecture for individualized media publishing;

FIG. 3 illustrates a block flow diagram of an exemplary embodiment of a method for setting up an account for individualized media publishing;

FIG. 4 illustrates a block flow diagram of an exemplary embodiment of a method for preparing an e-book for individualized media publishing;

FIG. 5 illustrates a block flow diagram of an exemplary embodiment of a method for a point of request or point of sale process of purchasing a customized e-book;

FIG. 6 illustrates a block flow diagram of an exemplary embodiment of a method for customization of the e-book using a web based application;

FIG. 7 illustrates an exemplary screenshot of a log in page;

FIG. 8 illustrates an exemplary screenshot of an inbox view;

FIG. 9 illustrates an exemplary screenshot of a customization page;

FIG. 10 illustrates an exemplary screenshot of a signing page;

FIG. 11 illustrates an exemplary screenshot of a typing page;

FIG. 12 illustrates an exemplary screenshot of an add image page;

FIG. 13 illustrates an exemplary screenshot of a preview page;

FIG. 14 illustrates a block flow diagram of an exemplary embodiment of a method for conversion and delivery of the customized e-book or individualized media; and

FIG. 15 illustrates an exemplary screenshot of a delivery page.

### DETAILED DESCRIPTION

Detailed embodiments of systems and methods for individualized media publishing are disclosed herein, however, it is to be understood that the disclosed embodiments are merely exemplary of the systems and methods for individualized media publishing, which may be embodied in various forms. Therefore, specific functional details disclosed herein are not to be interpreted as limiting, but merely as a basis for the claims and as a representative basis for teaching one skilled in the art to variously employ the systems and methods disclose herein.

Generally, the systems and methods disclosed herein include and may be implemented within a computer, computer system, and/or network of computer systems having one or more databases and other storage apparatuses, servers, and additional components, such as processors or microprocessors, modems, terminals and displays, non-transitory computer-readable media, algorithms, software, modules, and other computer-related components. The computer systems are especially configured and adapted to perform the functions and processes of the systems and methods as disclosed herein. In an illustrative embodiment, the functions and processes of the systems and methods as disclosed herein are embodied in a stand alone application, an application for use by mobile devices, and/or a web-based application which may include one or more graphical user interfaces (GUIs) that may be accessed over a network such as the Internet.

As disclosed herein, the systems are shown in an exemplary environment in which the systems interact with one or more consumers and/or content creators directly, indirectly, and/or through a third party intermediary. A consumer includes, for example, an individual or entity that may own, obtain, request, receive, and/or purchase an electronic work or a custom electronic work, and/or request customization of the electronic work, including but not limited to a reader of an electronic book (“e-book”). A content creator includes but is not limited to an author, a publisher, a copyright owner, a licensee, and/or a user having permission and/or authorization to edit an electronic work. An electronic work includes but is not limited to electronic or digital representations of literary or written works or recordings, musical works or recordings, dramatic works, pantomimes and choreographic works, pictorial, graphics, and sculptural works, sound recordings, architectural works, and any work that is subject of copyright protection. Electronic work includes but is not limited to e-books, music or sound files, image files, video files, and any combination thereof Moreover, electronic work includes digital greeting cards, digital yearbooks, digital scrapbooks, and other works of the type.

Communications between components in the systems and methods disclosed herein may be bidirectional electronic communication through a wired or wireless network. For example, one component may be networked directly, indirectly, through a third party intermediary, wirelessly, or otherwise with other components to enable communication between the components.

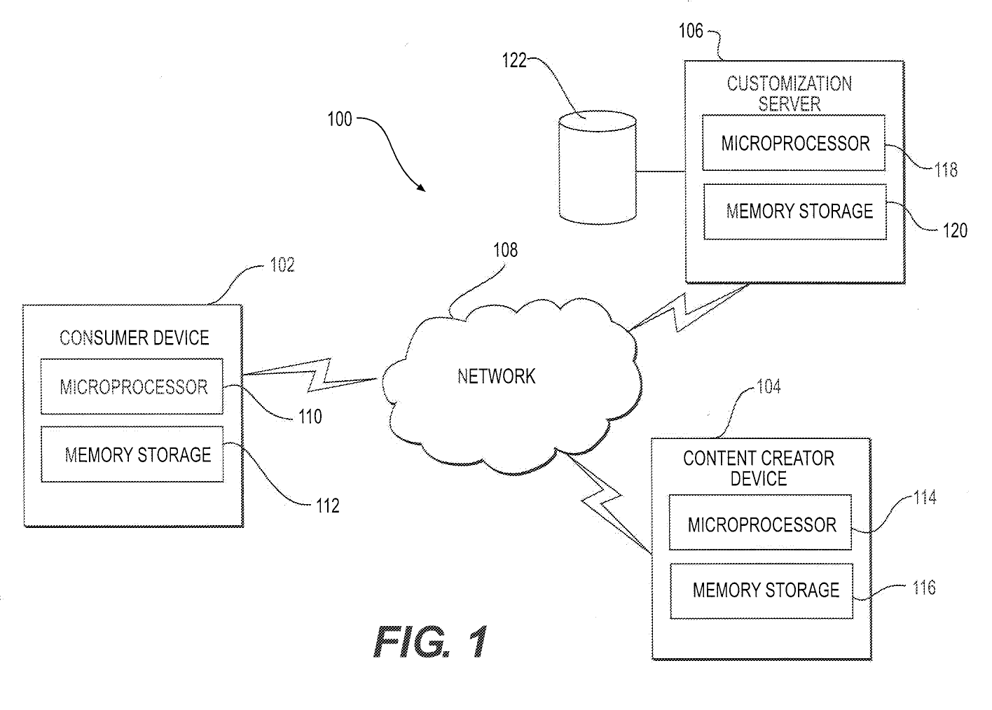

A system architecture for implementing the systems and methods for network content delivery according to an illustrative embodiment is described with reference to FIG. 1. As illustrated, the system 100 includes at least one consumer device 102, at least one content creator device 104, and at least one customization computer or server 106. Generally, the consumer device 102, content creator device 104, and customization server 106 are in communication with one another via a network 108. In an illustrative embodiment, the network is the World Wide Web (W3) and/or the Internet but may include other types of networks such as communications networks, Local area networks (LANs), Metropolitan area networks (MANs), Campus area networks (CANs), Wide area networks (WANs), wireless networks, and other networks of the type.

The consumer device 102 may include a microprocessor 110 and a memory storage 112. The consumer device 102 may also contain a software product that is executable by the microprocessor 110 and may access the memory storage 112 to store and/or retrieve data in order to perform the functions of the consumer device 102 as disclosed herein. Similarly, the content creator device 104 may include a microprocessor 114, a memory storage 116, and contain a software product that is executable by the microprocessor 114 and may access the memory storage 116 to store and/or retrieve data in order to perform the functions of the content creator device 104 as disclosed herein.

In an illustrative embodiment, the consumer device 102 and the content creator device 104 may be an electronic communication device such as but not limited to a computer, tablet computer, personal digital assistant (PDA), cellular or mobile phone or handsets, smartphones, and other devices that may access, provide, transmit, receive, and modify information over wired or wireless networks. The customization server 106 may be an application server and/or an entity that offers customization services of electronic works. The customization server 106 may include a microprocessor 118, memory storage 120, and/or a database 122. In an illustrative embodiment, the customization server 106 contains a software product that is executable by the microprocessor 118 and may access the memory storage 120 and/or the database 122 to store and/or retrieve data in order to perform the functions of the flow charts described below. The software product may be a computer program, stored in a non-transitory computer-readable medium, that allows the microprocessor to perform the functions of the flow charts described below.

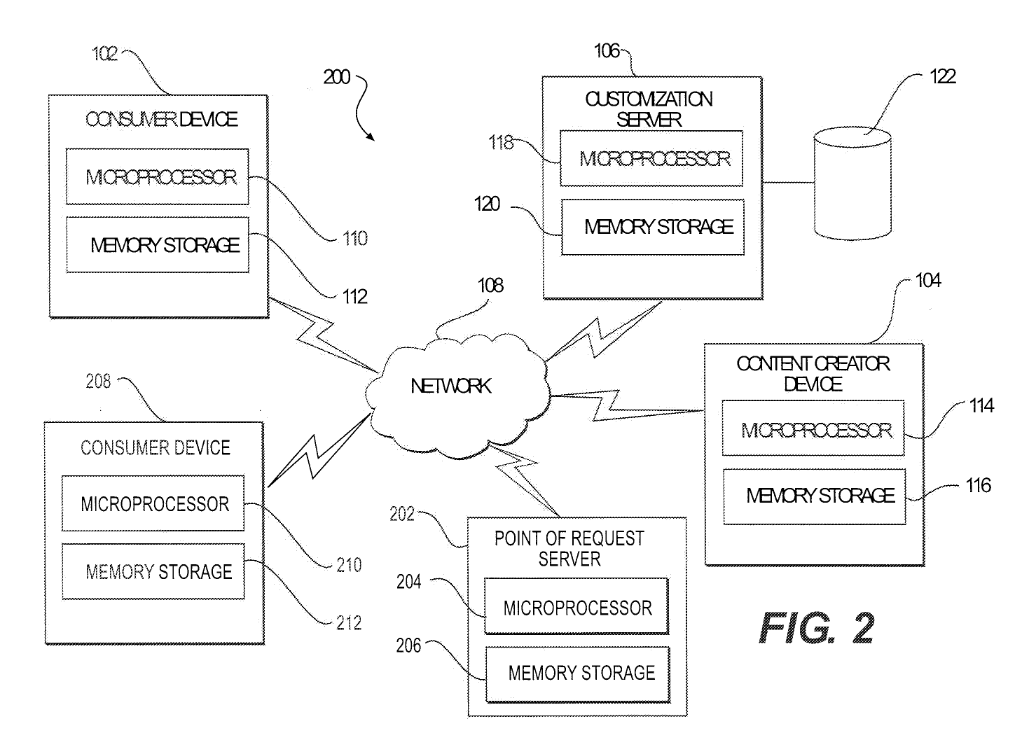

Another embodiment of the system architecture for implementing the systems and methods is described with reference to FIG. 2. As illustrated in FIG. 2, the system 200 includes the consumer device 102, content creator device 104, customization server 106, and may further include at least one point of request or point of sale computer or server 202 and/or another consumer device 208. The point of request server 202 and the consumer device 208 may be in communication with each other and/or the consumer device 102, content creator device 104, and/or customization server 106 via the network 108. In an illustrative embodiment, the point of request server 202 may be an electronic commerce (“e-commerce”) or commercial entity that provides, distributes, or sells electronic works and is a partner with and/or is authorized to provide, distribute, sell, and/or offer for sale the services of the customization server 106. The point of request server 202 may include a microprocessor 204 and a memory storage 206. The point of request server 202 may also contain a software product that is executable by the microprocessor 204 and may access the memory storage 206 to store and/or retrieve data in order to perform the functions of the point of request server 202 as disclosed herein.

Further, the consumer device 208 may include a microprocessor 210 and memory storage 212. The consumer device 208 may also contain a software product that is executable by the microprocessor 210 and may access the memory storage 212 to store and/or retrieve data in order to perform the functions of the consumer device 208 as disclosed herein.

In an illustrative embodiment, the systems described above, are configured to allow a content creator, for example an author and/or publisher, to add new or custom content to an electronic work. The content may be in the form of a written message, typed message, sound recording, video recording, image or photograph, any other types of messages that express any idea, and any combination thereof.

In an illustrative embodiment, the systems and methods may be implemented to allow authors of e-books to write or insert new content (for example, a custom message, inscription or dedication, and/or a digital autograph or signature) into an existing digital book or e-book at the time the e-book is sold. For example, the systems and methods disclosed herein enable authors to add custom messages and/or sign their e-books.

In an illustrative embodiment, the systems and methods may be implemented to allow authors of e-books to write or insert new content into an existing digital book or e-book after the e-book has been obtained or purchased, for example after the point of sale or after the e-book has been obtained free of charge. In this illustrative embodiment, a notice and form may be embedded in the e-book before it is distributed or sold that allows consumers to request a custom message, inscription and/or signature by the author. The request form may be submitted to the customization server and the author may be notified of the request, as discussed in further detail below. This may allow the systems and methods to be used for promotional electronic works that are not sold but may be used for purposes of review and/or donation.

Further, the systems and methods disclosed herein may allow authors and/or publishers to create unique or special edition copies for purposes of review, to celebrate special occasions, or any other purpose where the author wishes to communicate with either a single consumer or a small sub-set of the author's readers. It should be appreciated by those skilled in the art, however, that the systems and methods described herein may be implemented and used with other types of electronic or digital works, including but not limited to electronic or digital representations of literary or written works or recordings, musical works or recordings, dramatic works, pantomimes and choreographic works, pictorial, graphics, and sculptural works, sound recordings, architectural works, and any work that is subject of copyright protection. This includes but is not limited to e-books, music or sound files, image files, video files, and any combination thereof.

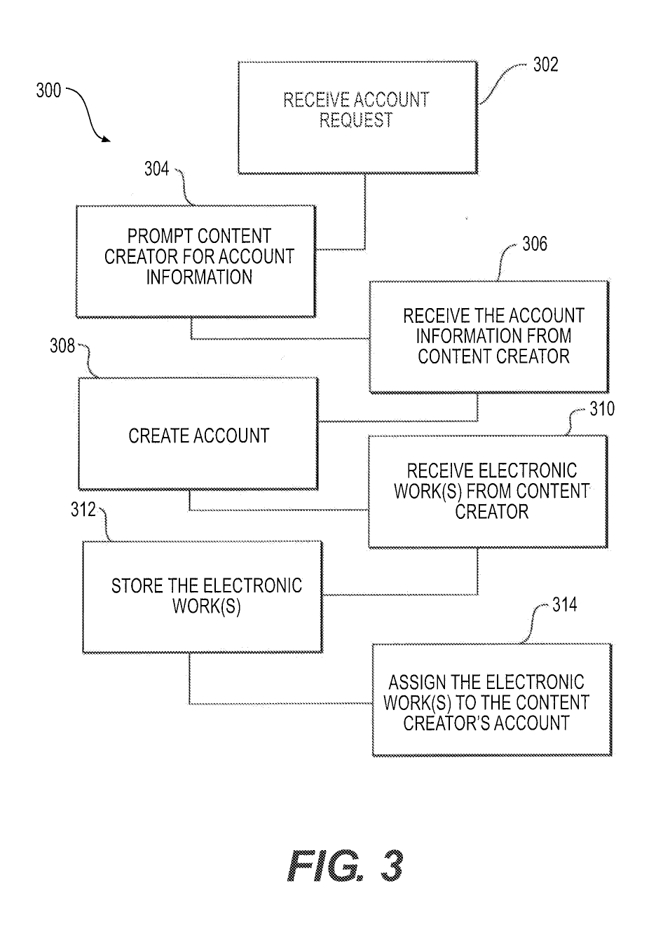

The content creator may create an account on the customization server 106 to allow the content creator to insert content into the electronic work. A block flow diagram 300 of a method of creating the account and preparing an e-book for individualized media publishing according to an illustrative embodiment is described with reference to FIGS. 1-3. The content creator creates an account with the customization server 106. The content creator may create an account with the customization server 106, by accessing a web portal or web application program interface to the customization server 106, via the content creator device 104 and requesting an account. The customization server 106 receives the request and begins the account set-up process, illustrated as step 302. Upon receiving the request, the customization server 106 may assign certain account information to the content creator and/or prompt the content creator to enter certain account information, via the content creator device 104, such as a set of credentials, for example a user name and password, and other personal identification information, which may be used to identify and/or authenticate the content creator, illustrated as step 304. In an illustrative embodiment, the customization server 106 presents the content creator with fields and/or drop down menus to be filled in by the content creator through the web based application. The content creator enters the account information, and transmits the account information to the customization server 106. The customization server 106 then receives the account information from the content creator, illustrated as step 306, and creates an account for the content creator on the customization server 106, illustrated as step 308.

After the account is created, the customization server 106 may allow the content creator to upload electronic works to the customization server 106 through the web based application. In an illustrative embodiment, the content creator uploads one or more electronic works, such as e-books, to the customization server 106, via the content creator device 104. The customization server 106 receives the electronic works, illustrated as step 310. The customization server 106 stores the electronic works in the memory storage 120 and/or the database 122, illustrated as step 312, and assigns the uploaded electronic works to the content creator's account, illustrated as step 314. The memory storage 120 and/or the database 122 may be part of and/or electronically connected (e.g., either wired or wireless communications) with the customization server 106. In an illustrative embodiment, the uploaded electronic work is an e-book. The e-book may be in an electronic format, including but not limited to an ePub® format (ePub® is a registered trademark of the Open eBook Forum DBA International Digital Publishing Forum, New York, N.Y. for electronic books), a MOBI format, and/or other electronic formats. Generally, MOBI format derives from MobiPocket e-reading software/technology, and MOBI files may be opened using software, for example Mobipocket Reader Desktop, on computers, smartphones, PDAs, electronic readers, for example the Amazon Kindle® (Amazon Kindle® is a registered trademark of Amazon Technologies, Inc., Reno, Nev.), as well as other such devices.

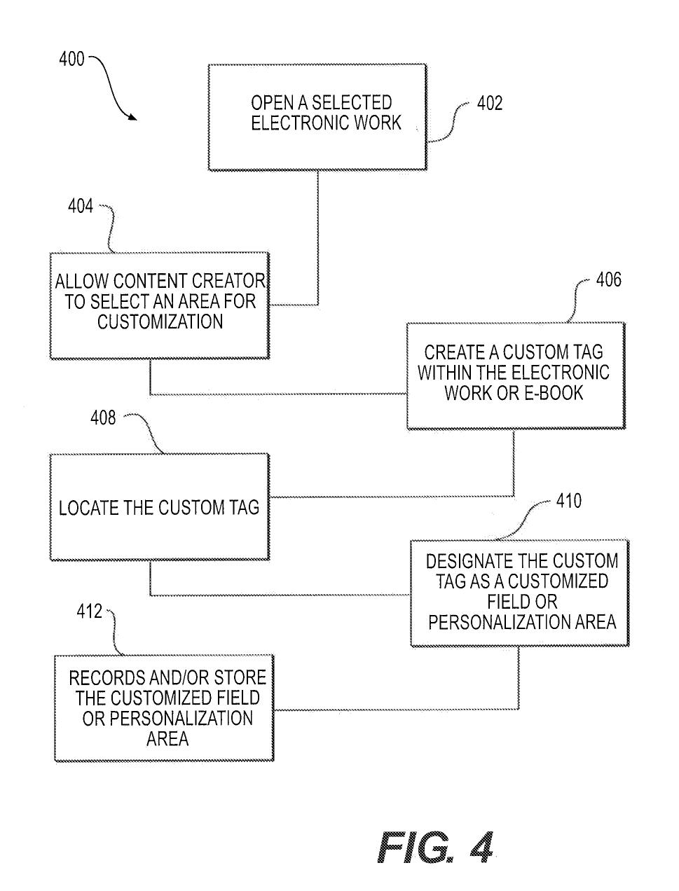

The customization server 106 may prepare the uploaded e-book for a customization process. A block flow diagram 400 of a method of preparing the e-book according to an illustrative embodiment is described with reference to FIGS. 1, 2, and 4. The content creator selects the e-book that the content creator desires to prepare for customization through a web based application. The customization server 106 may make the e-book available for display to the content creator, via the content creator device 104, illustrated as step 402. For example, the customization server 106 may open or make the selected e-book available for display with a digital reader application. The customization server 106 allows the content creator to select an area or particular page of the e-book and location within that page, through the web based application, where one or more custom or personalized messages and/or content may be inserted, illustrated as step 404. This may create a custom tag within the e-book, illustrated as step 406. The selected area is transmitted to the customization server 106. The customization server 106 locates the custom tag, illustrated as step 408, and designates the selected area as a Customized Field or Personalization Area, illustrated as step 410, which may be assigned an area within the e-book where a customized message created via the customization server 106/web based application may appear. The customization server 106 records and/or stores the Customized Field or Personalization Area, for example in the memory storage 120 and/or the database 122, illustrated as step 412. Further, the customization server 106 permits the content creator to return to the e-book and change or modify where the Customized Field or Personalization Area has been placed.

In an illustrative embodiment, the customization server 106 may create Customized Field or Personalization Area by inserting a marker such as an html div tag with a class=“inscription” and an img tag for a placeholder image into the existing html for the selected page of the e-book. The customization server 106 may also add the placeholder image referenced in the img tag to the e-book package. This placeholder image may be a simple transparent one pixel image or more commonly the author's signature. Additionally, the customization server 106 may add a set of rules to the stylesheet (CSS) for the e-book to allow an inserted message or content to be centered and have a reasonable amount of space between it and any other items on the selected page of the e-book.

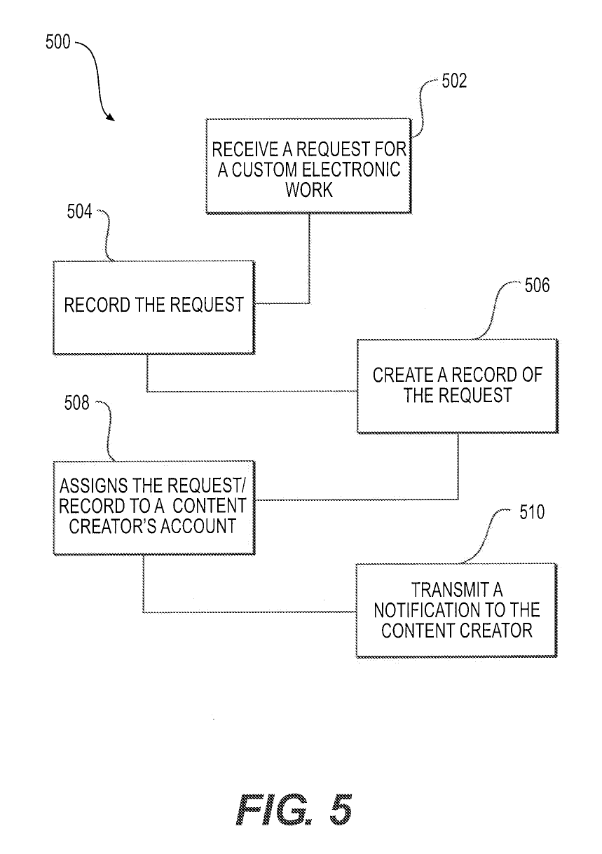

An exemplary manner in which the e-book may be customized is discussed in connection with FIG. 5. A block flow diagram 500 of a method of a point of request or a point of sale process for obtaining or purchasing a customized e-book according to an illustrative embodiment is described with reference to FIGS. 1, 2, and 5. A consumer may access a seller or distributor of electronic works (for example, the point of request server 202) and communicate a request, via the consumer device 102, to the point of request server 202 to obtain or purchase and/or have a custom inscription placed in an e-book. In this illustrative embodiment, the process is described for a consumer obtaining an e-book. It should be appreciated by those skilled in the art, however, that the process may be used in connection with other electronic works as well.

The point of request server 202 receives the request. The request may include but is not limited to the title and name of the author of the desired e-book, name and email address of the consumer, and the file format of the e-book requested by the consumer. The request may also include a selected or customized message, image, and/or content the consumer wishes to have inserted into the e-book by the content creator or author. For example, the consumer may be purchasing the e-book as a gift and may want the custom message or content to include the name of or a photograph of the recipient of the gift.

The point of request server 202 receives the request from the consumer device 102 and transmits the request to the customization server 106. To transmit the request, the point of request server 202 may access a web application program interface that, connects the point of request server 202 to the customization server 106, via the network 108. In alternative embodiment, the seller or distributor may be the customization server 106. In this alternative embodiment, the consumer may obtain or purchase the e-book directly from the customization server 106 and thus the consumer may send the request directly to the customization server 106, via the consumer device 102, bypassing the point of request server 202.

Upon receiving the request, illustrated as step 502, either from the consumer or the distributor or seller, the customization server 106 records the request and/or order in the memory storage 120 and/or the database 122, illustrated as step 504. The customization server 106 creates a record of the request, illustrated as step 506, and assigns the record to the appropriate content creator's account, illustrated as step 508. The customization server 106 transmits a message or request, for example an email notification, to the content creator device 104 informing the content creator that a request has been made for a signature and/or desired/custom message or content to be inserted into an e-book, illustrated as step 510. Upon receiving the notification, the content creator may enter or log into the content creator's account on the customization server 106, by accessing the web application, via the content creator device 104.

A block flow diagram 600 of a method and corresponding screenshots for customizing the e-book using the web based application according to an illustrative embodiment is described with reference to FIGS. 1, 2, and 6-13. The content creator accesses and/or logs into the web based application, via the content creator device 104, for example, using the set of credentials, as described above. The web based application is configured to connect the content creator, via the content creator device 104, with the customization server 106 to allow the content creator to begin the customization of an e-book.

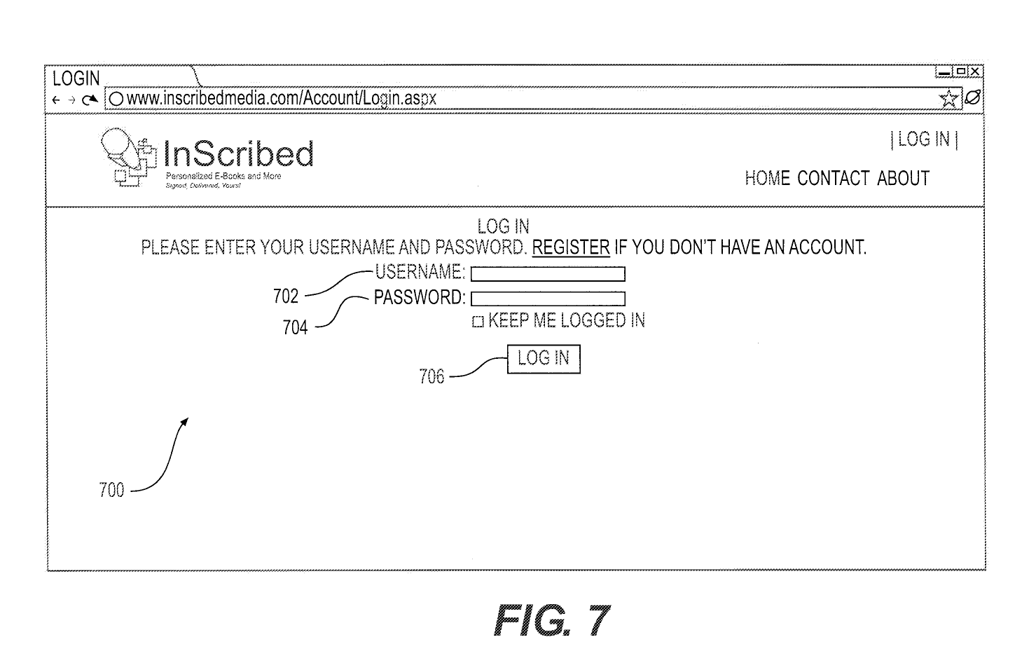

Referring to FIG. 7, a screenshot of a log in page of the web based application is illustrated. As illustrated in FIG. 7, the log in page 700 presents the content creator with a username input field 702 and a password input field 704, via the web application. The content creator may enter the content creator's username and password, and select a “Log In” button 706 to access the content creator's account.

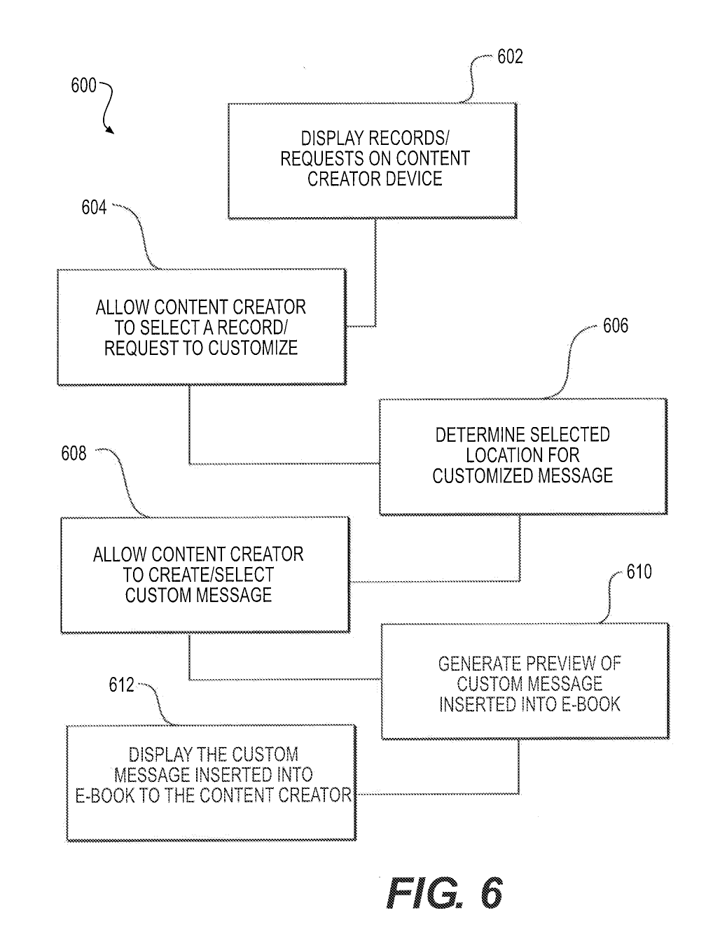

Referring back to FIG. 6, after log in the content creator may access or may be presented with an inbox feature of the content creator's account. The inbox may display or list the pending requests associated with that content creator, illustrated as step 602.

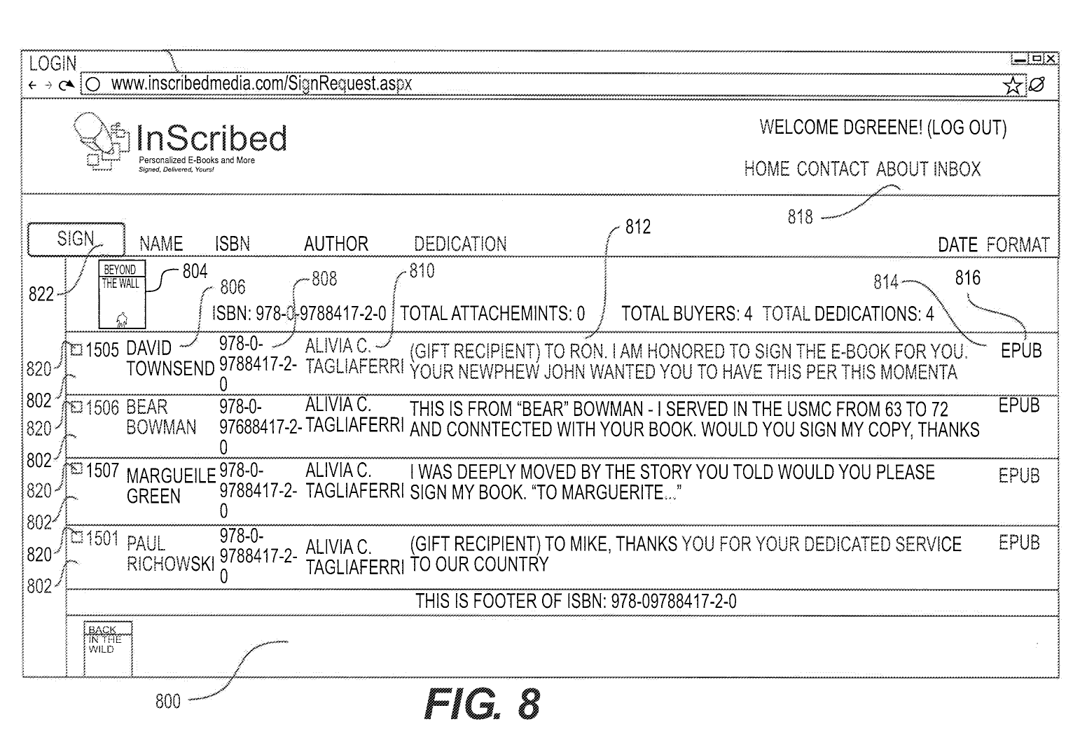

A screenshot of the inbox feature of the web based application is illustrated in FIG. 8. As illustrated in FIG. 8, the content creator's inbox page 800 may include a list of pending requests 802. Each pending request 802 may be associated with a title 804, consumer name 806, an International Standard Book Number (ISBN) 808, an author name 810, a dedication 812, a date 814, and a format 816. Alternatively, the content creator may access the inbox 800 by selecting the inbox link/button 818 from a home page.

Referring to FIGS. 6 and 8, the customization server allows the content creator to select an e-book to customize, illustrated as step 604. The content creator may select an e-book from a list of e-books that the content creator is a contributor to (and approved for) to customize or searches against a catalog of books using the title, ISBN and/or other identifying information of the e-book. In an illustrative embodiment, the content creator may select the desired record/request to customize by checking a box 820 next to the records/request and selecting a “Sign” button 822. Further, a number of other methods may be used for choosing an electronic work or e-book, for example the content creator selecting a file from the content creator device 104. Those skilled in the art should appreciate other methods in selecting an electronic work from content creator device 104.

In addition to choosing the e-book to customize, the content creator may also select or input other information, such as but not limited to the recipient of the e-book, how the e-book should be delivered, and/or what format is needed for the e-book. Exemplary formats include but are not limited to: ePub® used on the Apple iPad® and iPhone® (iPhone® and iPad® are registered trademarks of Apple Inc., Cupertino, Calif.) and MOBI used on the Amazon Kindle® (Amazon Kindle® is a registered trademark of Amazon Technologies, Inc., Reno, Nev.).

Upon selecting the desired record/request, the customization server 106 determines the location within the selected e-book where custom content is to be inserted, illustrated as step 606. For example the customization server 106 may look up the Customized Field created as described above. The customization server 106 also allows the content creator to create or select the custom content to be inserted into the e-book, illustrated as step 608. In an illustrative embodiment, the customization server 106 presents a GUI through the web based application to the content creator via the content creator's device 104.

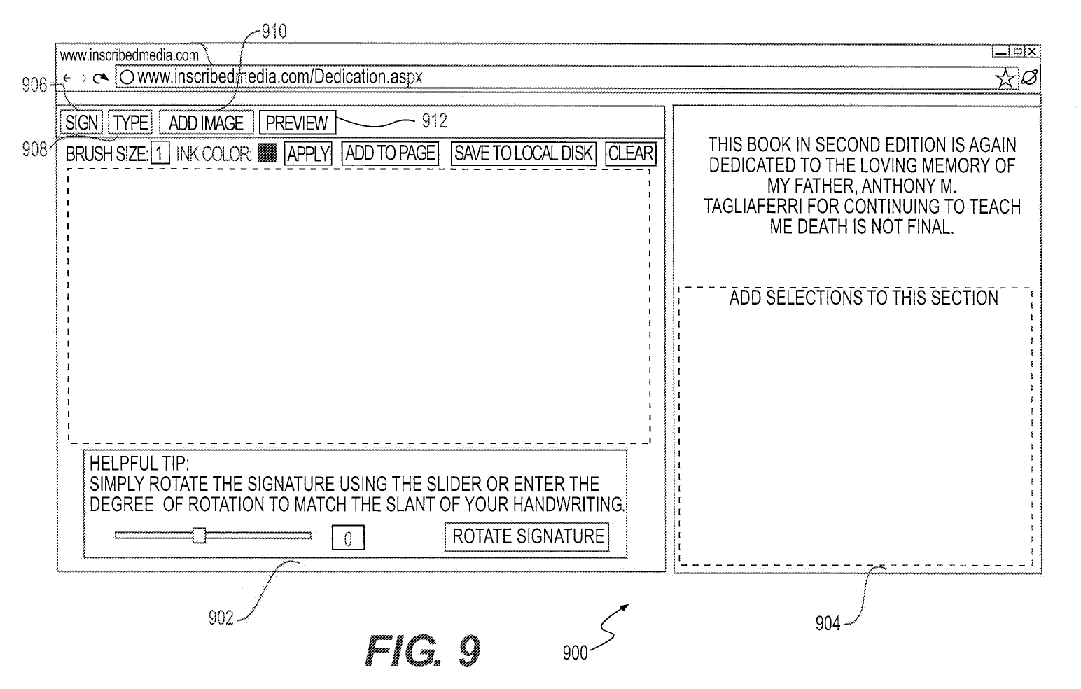

A screenshot of a customization page of the web based application is illustrated in FIG. 9. As illustrated in FIG. 9, the customization page 900 may be split into a first panel 902 and a second panel 904. The first panel 902 includes a “Sign” button 906, a “Type” button 908, an “Add Image” button 910, and a “Preview” button 912. The second panel 904 displays the page of the e-book into which the custom content is to be inserted.

Upon selecting the “Sign” button 906, the content creator may create content within the web based application using the content creator device 104, such as but not limited to a graphics tablet or a touch screen enabled device such as an iPad®. Additionally, the content creator may create new content within the web based application using, for example a mouse of the content creator device 104.

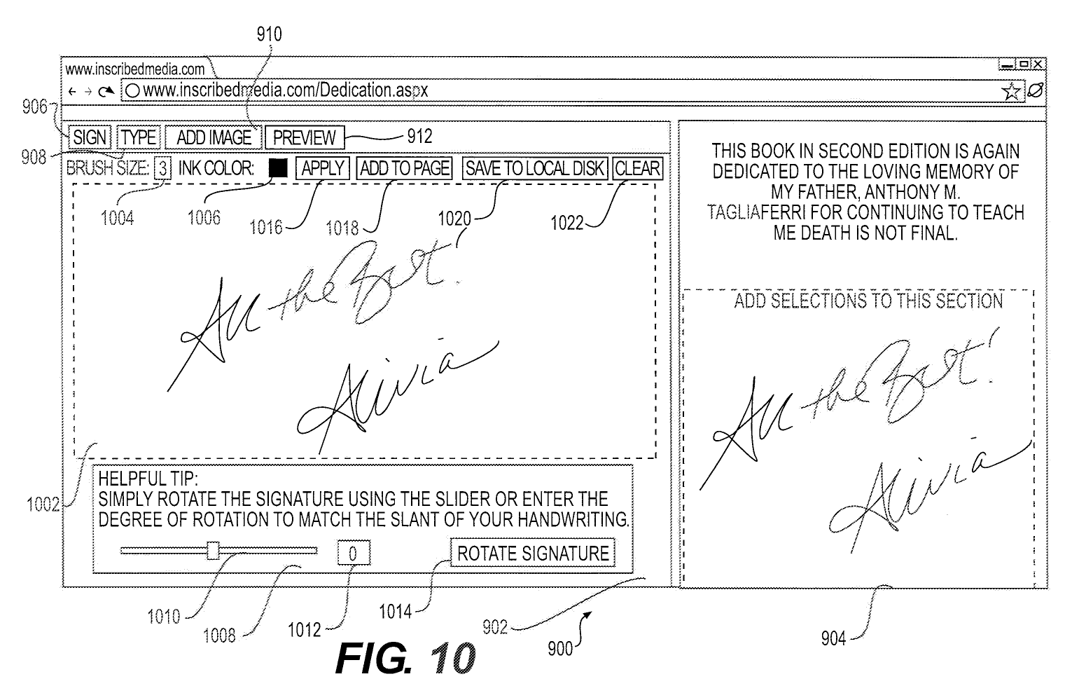

A screenshot of the sign feature of the web based application is illustrated in FIG. 10. As illustrated in FIG. 10, the sign feature of the web based application includes a sign field 1002 and editing tools. The editing tools may include but are not limited to a selectable/variable “Brush Size” 1004, a selectable/variable “Ink Color” 1006, and a rotation tool 1008. The rotation tool 1008 may include a slider 1010, a rotation input box 1012 and a “Rotate Signature” button 1014. Other types of editing tools include but are not limited to re-sizing and/or manipulation of the size of the signature/message and/or cropping of the signature/message.

For example, the content creator may sign and/or write a message into the sign field 1002, using the content creator device 104, and edit the signature/message using the editing tools. For example, the content creator may change the “Brush Size” 1004 and/or change the “Ink Color” 1006, and select an “Apply” button 1016 to apply the changes to the signature/message. The content creator may also rotate the signature/message using the rotation tool 1008. To rotate the signature/message using the rotation tool 1008, the content creator may either manipulate the slider 1010 or input a desired degree of rotation into the rotation input box 1012 and select the “Rotate Signature” button 1014. The web based application/customization server 106 may also allow the content creator to add the signature/message to the selected page of the e-book by selecting an “Add To Page” button 1018, save the signature/message to a local disk by selecting an “Save To Local Disk” button 1020, and/or clear the signature/message from the sign field 1002 by selecting a “Clear” button 1022. By selecting the “Add To Page” button 1018, the web based application/customization server 106 adds the signature/message to the selected page of the e-book in the second panel 904 for the content creator to view.

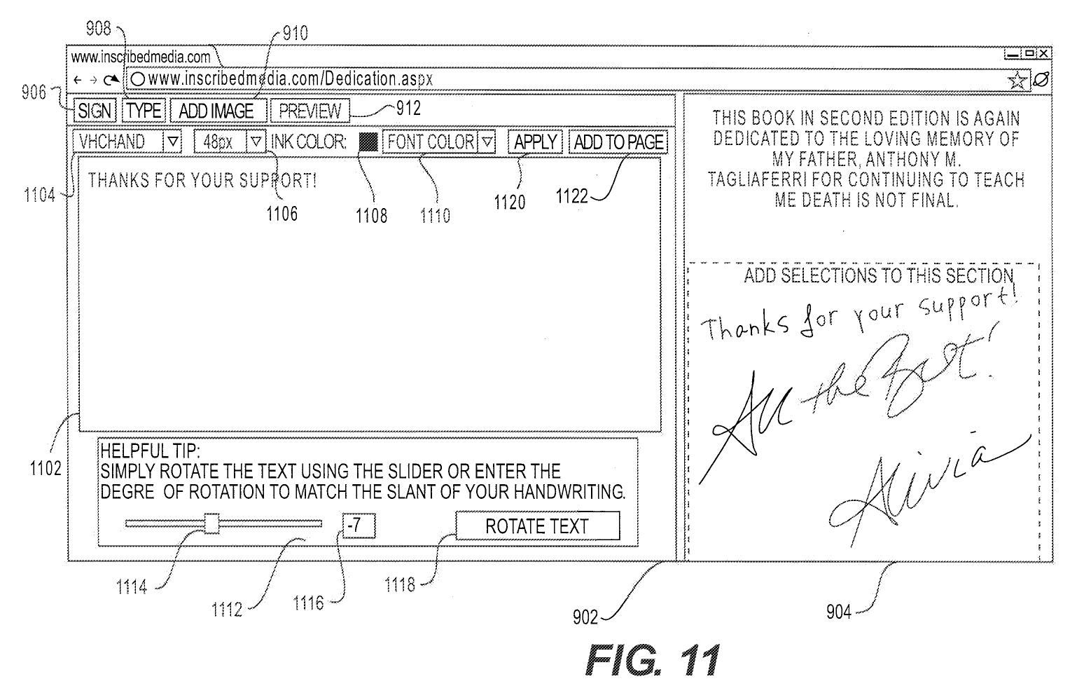

Upon selecting the “Type” button 908, the content creator may type a message within the web based application and the customization server 106 may convert the text to an image using a font that looks like handwriting. A screenshot of the type feature of the web based application is illustrated in FIG. 11. As illustrated in FIG. 11, the type feature of the web based application includes a text input field 1102 and editing tools. The editing tools include a selectable font type 1104, a selectable, font size 1106, a selectable/variable “Ink Color” 1108, a selectable/variable font color 1110, and a rotation tool 1112. The rotation tool 1112 may include a slider 1114, a rotation input box 1116 and a “Rotate Text” button 1118. Other types of editing tools include but are not limited to re-sizing and/or manipulation of the size of the text image and/or cropping of the text image.

For example, the content creator may type a message into the text input field 1102, using the content creator device 104, and edit the message using the editing tools. The content creator may change the font type 1104, the font size 1106, the “Ink Color” 1108, and/or change the font color 1110, and select an “Apply” button 1120 to apply the changes to the message. The content creator may also rotate the message using the rotation tool 1112. To rotate the message using the rotation tool 1112, the content creator may either manipulate the slider 1114 or input a desired degree of rotation into the rotation input box 1116 and select the “Rotate Text” button 1118. The web based application/customization server 106 may also allow the content creator to add the message to the selected page of the e-book by selecting an “Add To Page” button 1122. By selecting the “Add To Page” button 1018, the web based application/customization server 106 adds the message to the selected page of the e-book in the second panel 904 for the content creator to view.

Upon selecting the “Add Image” button 910, the content creator may upload content that the content creator has already created by some external means, such as the content creator device 104, to the customization server 106. The content creator may choose content from a library of images and other content that the content creator has created previously and/or saved to library on the customization server 106, such as a scan of the content creator's signature or a previous message. Additionally, the content creator may receive specific content from the consumer that the consumer would like the content creator to insert, and upload such content to the customization server 106. For example, the consumer may include such content in the request when purchasing the e-book, as described above, which may be forwarded to the content creator via the point of request server 202 and/or the customization server 106. The consumer may send such content directly to the content creator via email or other communication.

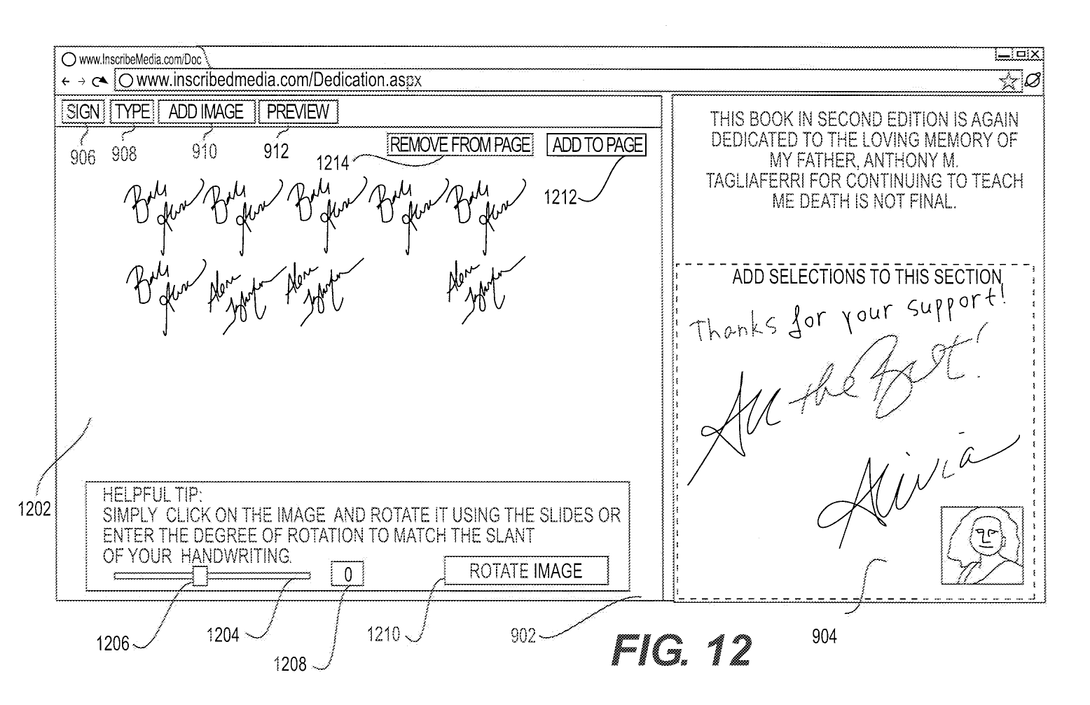

A screenshot of an add image feature of the web based application is illustrated in FIG. 12. As illustrated in FIG. 12, the add image feature of the web based application includes an image field 1202 and a rotation tool 1204. The rotation tool 1204 may include a slider 1206, a rotation input box 1208 and a “Rotate Image” button 1210. For example, the content creator may upload one or more images to the image field 1202, using the content creator device 104. The content creator may also rotate the image using the rotation tool 1204. To rotate the image using the rotation tool 1204, the content creator may either manipulate the slider 1206 or input a desired degree of rotation into the rotation input box 1208 and select the “Rotate Image” button 1210. The web based application/customization server 106 also allows the content creator to add the image to the selected page of the e-book by selecting an “Add To Page” button 1212. By selecting the “Add To Page” button 1212, the web based application/customization server 106 adds the signature/message to the selected page of the e-book in the second panel 904 for the content creator to view. Additionally, the web based application/customization server 106 also allows the content creator to remove the image from the selected page of the e-book by selecting a “Remove From Page” button 1214. Other types of editing tools include but are not limited to allowing re-sizing and/or manipulation of the size of the image, and/or cropping of the image.

In an illustrative embodiment, the web based application may also include an add media or import media feature. The add media feature may allow the content creator to upload, import, or add media, including audio or sound recordings, and/or video files to the customization server 106. The customization server 106 may then incorporate the media into the selected page of the e-book. Thus, it should be appreciated by one skilled in the art that all types of media may be incorporated into an electronic work.

Several images and/or other files may be combined to create the final message. For example the image derived from the text may be combined with an image of the content creator's real signature, a photo, and/or other content of the type to create a more attractive custom message. Additionally, the content creator may further customize the signature and message by selecting font color, brush width, font size, and rotation of signature, message or image, and other customization tools of the type.

Once the custom message has been created or selected, the author may preview the custom message within the selected e-book, by selecting a “Preview” button 912 or pane within the web based application. Referring back to FIG. 6, to present the author with the preview of the custom message, the customization server 106 makes a copy of the selected e-book components and looks up the selected page at which the custom message is to be inserted in the memory storage 120 and/or the database 122. The customization server 106 generates the custom message page, illustrated as step 610, and displays it to the content creator via the content creator device 104, illustrated as step 612.

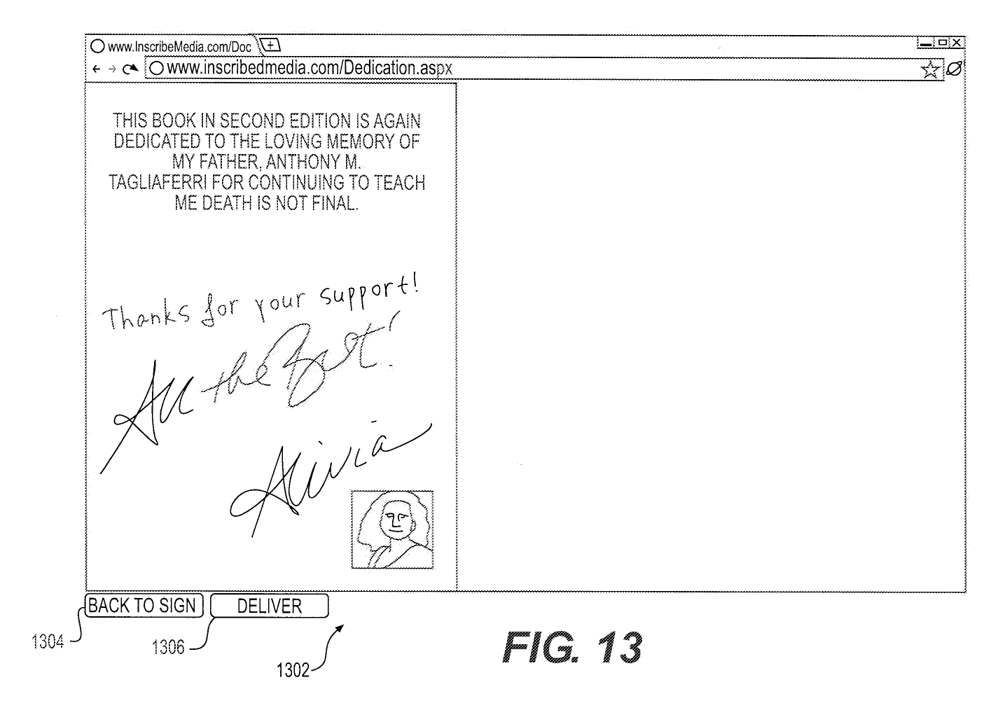

A screenshot of the preview page of the web based application is illustrated in FIG. 13. Referring to FIG. 13, the preview page 1302 of the web based application displays the selected page of the e-book with the custom message inserted into the selected page to the content creator. The preview page also includes a “Back To Sign” button 1304 and a “Deliver” button 1306. This allows the content creator to view the customized message and layout within the customized field of the e-book. The content creator may then go back and sign again, edit, or modify the custom content if the content creator is not satisfied with the preview by selecting the “Back To Sign” button 1304, or move forward and deliver the final individualized media file to the consumer in a specific format by selecting the “Deliver” button 1306. This preview of the page is generally updated as the content creator changes the custom message/content. While the exemplary screenshots are illustrated and described in connection with certain command language for the various buttons or links (for example “Sign,” “Type,” “Add Image,” “Apply,” “Preview,” “Back to Sign,” “Deliver,” etc.), it should be appreciated by one skilled in the art that the command language is merely exemplary and may be modified as desired. For example, the “Back To Sign” button 1304 may alternatively be a “Back” button, a “Previous Page” button, or include other command language of the type.

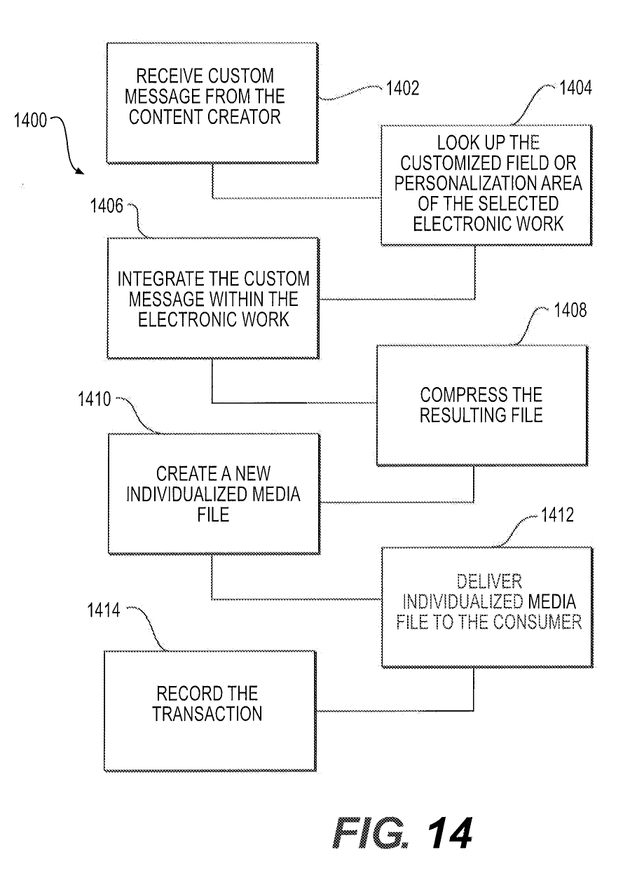

Once the author is satisfied with the custom message page, the custom message page is uploaded to the customization server 106 and the existing placeholder image is replaced by this new image. A block flow diagram 1400 of a method of conversion and delivery of the customized e-book or individualized media according to an illustrative embodiment is described with reference to FIGS. 1, 2, and 14. The customization server 106 integrates the personalized message within the customized field with the e-book stored in the memory storage 120 and/or the database 122. The customization server 106 receives the custom message from the content creator, illustrated as step 1402. The customization server 106 looks up the Customized Field or Personalization Area of the selected e-book where the custom message is to be integrated, based on the tags assigned to the book in the preparation process described above, illustrated as step 1404. The customization server 106 inserts the custom message into the Customized Field or Personalization Area of the selected e-book, illustrated as step 1406. The customization server 106 may compress the e-book file for storage and/or transmission, illustrated as step 1408. The customization server 106 creates an e-book file which is the individualized media, illustrated as step 1410. The customization server 106 may also convert the file into the format preferred by the consumer or content creator including but not limited to an ePub (standard format), MOBI (Amazon Kindle® propriety format), and/or other format types.

In an illustrative embodiment, the customization server 106 may also place an indicator on the individualized or custom e-book, such as labeling the e-book as a commemorative edition. The customization server 106 may also verify, authenticate, and/or indicate in or on the e-book that the content creator, such as the author, is the person who signed and/or inserted the custom content into the e-book.

The resulting individualized media file may be delivered to the consumer in the desired format, illustrated as step 1412, and the transaction is recorded by the customization server 106 in the memory storage 120 and/or the database 122, illustrated as step 1414. For example, the customization server 106 may send the custom e-book to the consumer, by transmitting the custom e-book to the consumer device 102. Further, the customization server 106 may include a custom message determined by the content creator in the delivery of the e-book.

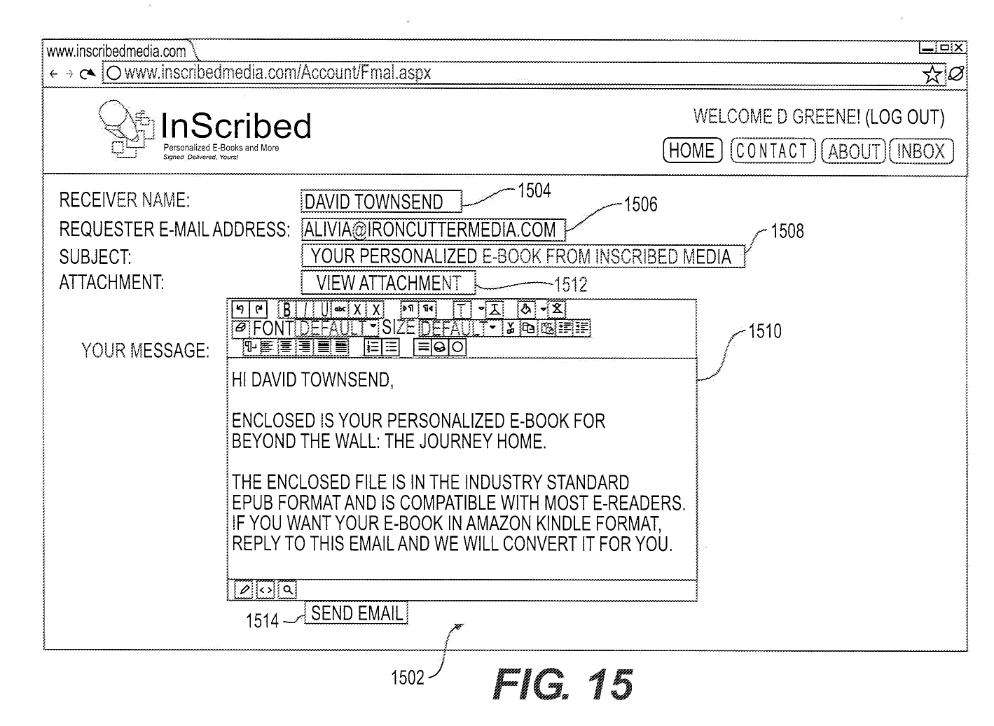

A screenshot of an email delivery page of the web based application is illustrated in FIG. 15. As illustrated in FIG. 15, the email delivery page 1502 may include a receiver name input field 1504, a recipient email address field 1506, a subject field 1508, and a message input area 1510. The customized e-book or individualized media may be automatically attached to the email by the customization server, as illustrated by the attachment 1512. Alternatively, the content creator may choose or select the desired customized e-book or individualized media to be attached to the email.

In an illustrative embodiment, the content creator may enter the name and email address of the consumer into the receiver name input field 1504 and the recipient email address field 1506. Additionally, the content creator may enter a desired subject and message into the subject field 1508 and the message input area 1510. Alternatively, the customization server 106 may automatically input the above information including a particular message into the message input area 1510. The particular message may be for example, a customized message to the individual consumer, a standard message chosen by the author, a default message, and/or other messages of the type. To send the customized e-book or individualized media to the consumer, the content creator selects a “Send Email” button 1514, and the customized server 106 transmits the email to the consumer via email.

Alternatively, the content creator may transmit the customized e-book or individualized media directly from the content creator device 104 to the consumer, for example via email. Additionally, the customized e-book or individualized media may be transmitted to the point of request server 202 by the customization server 106 or the content creator, which then transmits the customized e-book or individualized media to the consumer by transmitting the custom e-book to the consumer device 102, for example via email. The customized e-book may also be saved and/or stored on a computer, disk, storage device, and/or mobile device and transmitted or delivered to the consumer.

In an illustrative embodiment, the customization server 106 stores each individualized message creation for future access or re-delivery. When the customization server 106 records the transaction, the customization server 106 may also update the record with one or more of the following: date signed, date delivered, format delivered, and other information of the type. The content creator may access the content creator's “My Profile” page or view within the content creator's account on the customization server 106, which may detail the records of requests and history of signings with any special notes. Upon accessing the content creator's “My Profile” page, the content creator may view the content creator's account library for each of the content creator's titles, preferences, images, and/or messages. This enables the content creator to view a history of the content creator's signings by logging in to the content creator's account and viewing a history page, which may be within the “MyProfile” page. Reports with the above information may also be prepared by the customization server 106 and downloaded by the content creator.

In an illustrative embodiment, the consumer, instead of the content creator, may insert custom content into the electronic work, for example via the consumer device(s) 102 and/or 208 in accordance with the above description. However, it should be appreciated that the electronic work may be copyright protected, and the consumer may require permission granted by the copyright owner(s) of the electronic work in order to insert custom content into the electronic work.

Additionally, the consumer may create custom content, for example personalized messages, bookplates, and/or cards to be inserted into, attached to, bundled with, sent or transmitted along with the electronic work or customized electronic work. For example, a first consumer may desire to send an electronic work as a gift to a second consumer along with a gift card. In this example, referring back to FIG. 2, the first consumer, for example via the consumer device 102, may communicate with the point of request server 202 and/or the customization server 106 and request an electronic work to be transmitted or sent to the second consumer as a gift, for example via the consumer device 208. The first consumer may access the customization server 106 and create, upload, and/or select custom content for the gift card. The customization server 106 may integrate the custom content into the gift card and insert the gift card into, attach the gift card to, bundle the gift card with, and/or send or transmit the gift card with the electronic work.

In an illustrative embodiment, the customization server 106 may transmit the electronic work and gift card to the second consumer, for example via the consumer device 208, to the first consumer, for example via the consumer device 102, and/or to the point of request server 202. When the electronic work and gift card is transmitted to the point of request server 202, the point of request server 202 may transmit the electronic work and gift card to the second consumer, for example via the consumer device 208, and/or to the first consumer, for example via the consumer device 102. When the electronic work and gift card is transmitted to the first consumer, the first consumer may then transmit the electronic work and gift card to the second consumer, for example via the consumer device 208.

In an illustrative embodiment, the systems and methods described above may further include a number of optional features that may be desired, including but not limited to: the collection of billing or other business related data from the author, and ensuring that a file uploaded by the author is a valid image or the validation of the final e-book file before it is sent out or delivered to the consumer.

Although the embodiments described herein illustrate a content creator using the invention to sign e-books or consumers using the embodiments to individualize electronic works or media, it should be appreciated by one skilled in the art that the systems and methods disclosed herein may be used for the insertion of other custom messages. For example, other uses are the insertion of: customized advertising, commemorative edition messages, announcements of upcoming events, coupons, or any other custom message the content creator or consumer chooses. Furthermore, the process may be used for the insertion of multiple messages into different sections of an e-book or other electronic work or media.

While the systems and methods have been described and illustrated in connection with insertion of custom messages and images into e-books, it should be appreciated by one skilled in the art that other digital media may be inserted as well, such as audio and/or video elements. Further, it should be appreciated that any type of digital media may be customized by the systems and methods described above, including but not limited to magazine, news paper, audio, video, and other digital media files of the type.

While the systems and methods have been described and illustrated in connection with certain embodiments, many variations and modifications will be evident to those skilled in the art and may be made without departing from the spirit and scope of the disclosure. The systems and methods are thus not to be limited to the precise details of methodology or construction set forth above as such variations and modification are intended to be included within the scope of the disclosure.

What is claimed is:

1. A method of individualized media publishing comprising:
receiving, by one or more servers, an electronic work;
receiving, by the one or more servers, an indication of an area for customization within the electronic work;
creating, by the one or more servers, a custom field within the electronic work associated with the area for customization; and
storing, in a database or a memory storage, the custom field.

2. The method of claim 1, further comprising receiving, by the one or more servers, a request for a customized electronic work.

3. The method of claim 2, further comprising transmitting, by the one or more servers, a notification indicating the request for the customized electronic work.

4. The method of claim 1, further comprising receiving, by the one or more servers, customized content associated with the custom field.

5. The method of claim 4, further comprising inserting, by the one or more servers, the customized content into the custom field creating a customized electronic work.

6. The method of claim 5, further comprising transmitting, by the one or more servers, the customized electronic work.

7. The method of claim 5, further comprising generating, by the one or more servers, a preview of the customized electronic work

8. The method of claim 5, wherein the inserting the customized content further includes inserting, by the one or more servers, at least one of a message, an inscription or dedication, an autograph or signature, an image, a recording, and a video into the custom field.

9. A system for individualized media publishing comprising:
one or more servers, either individually or in combination, in communication with a content creator device and a consumer device, the one or more servers, either individually or in combination, configured to:
receive a request for a customized electronic work;
create a custom field within an electronic work;
insert customized content into the custom field creating the customized electronic work; and
electronically deliver the customized electronic work.

10. The system of claim 9, wherein the one or more servers, either individually or in combination, are further configured to receive a location of the custom field.

11. The system of claim 9, wherein the one or more servers, either individually or in combination, are further configured to receive the electronic work from the content creator device.

12. The system of claim 11, wherein the one or more servers, either individually or in combination, are further configured to transmit a notification message of the request to the content creator device.

13. The system of claim 11, wherein the customized content includes at least one of a message, an inscription or dedication, an autograph or signature, an image, a recording, and a video.

14. The system of claim 11, wherein the one or more servers are further configured to allow the customized content to be created via the content creator device.

15. A system for individualized media publishing comprising:
a server accessible by a content creator device, the server including a microprocessor; and
a database in communication with the server;
the microprocessor configured to run a computer program, stored in a non-transitory computer-readable medium, that allows the microprocessor to open an electronic work, create a custom field within the electronic work, and store the custom field in the database.

16. The system of claim 15, wherein the content creator device is electronically accessible to the server via a communications network.

17. The system of claim 15, wherein the microprocessor is further configured to create the custom field within the electronic work at a selected location received via the content creator device.

18. The system of claim 15, wherein the microprocessor is further configured to receive custom content including at least one of a message, an inscription or dedication, an autograph or signature, an image, a recording, and a video from the content creator device.

19. The system of claim 18, wherein the microprocessor is further configured to access the custom field stored in the database and insert the custom content into the custom field.

20. The system of claim 19, wherein the microprocessor is further configured to create a customized electronic work including the electronic work and the custom content.
